(19) United States
(12) Patent Application Publication
(10) Pub. No.: US 2009/0219126 A1
(43) Pub. Date: Sep. 3, 2009

(54) ALPHA-TURN COIL

(75) Inventors: Yoshihide GOTO, Yamagata (JP); Taiki Goto, Yamagata (JP); Yoichi Miura, Yamagata (JP); Naoto Takahashi, Yamagata (JP)

Correspondence Address: KRATZ, QUINTOS & HANSON, LLP, 1420 K Street, N.W., Suite 400, WASHINGTON, DC, 20005, US

(73) Assignee: GOTO ELECTRONIC CO., LTD., Sagae-shi (JP)

(21) Appl. No.: 12/166,620

(22) Filed: Jul. 2, 2008

(30) Foreign Application Priority Data
Feb. 29, 2008 (JP) 2008-049965

(51) Int. Cl. H01F 27/28

(52) U.S. Cl. 336/180

(57) ABSTRACT

An alpha-turn coil includes: a plurality of coil main bodies made by winding a wire rod having a desired diameter; and lead wire having a start part and a stop part formed integrally with outer peripheries of the coil main bodies, and connecting the coil main bodies to each other. The stop part of the lead wire of a forward coil main body is extended to the start part of the lead wire of a backward coil main body, and the lead wire is extended to compose the coil main body.

### CROSS REFERENCE TO RELATED APPLICATIONS

This application is on the basis of Japanese Patent Application No. 2008-049965, the contents of which are hereby incorporated by reference.

### BACKGROUND OF THE INVENTION

1. Field of the Invention

The present invention relates to an alpha-turn coil which is used in high frequency electronics, allows electronic parts using the alpha-turn coil to be small-sized, improve production efficiency of lead wire to drastically reduce the number of man-hour of a wiring process, and improve reliability and stability of the electronic parts.

2. Description of the Related Art

Conventionally, an alpha-turn coil is used for electric parts, and high frequency electrical parts. The alpha-turn coil is made of conductive wire rod, such as foil, and includes a foil-shaped winding wire having a pair of spiral parts facing each other, and having a skin effect. A winding direction of the winding wire is parallel to a surface of the foil. Inner peripheries of the spiral parts are connected to each other. (For example, see Patent Document 1)
[Patent Document 1] Japanese Published Patent Application No. 2003-173913

However, the conventional alpha-turn coil described in Patent Document 1 is made of conductive foil, and the spiral part is overlapped vertically in the surface direction of the foil. The spiral part is not wound from the inner periphery to the outer periphery. Namely, the spiral parts of the conventional alpha-turn coil described in the Patent Document 1 are not formed in the same plane via a start part integrally formed at the outer periphery of the spiral part and a stop part. The spiral parts of the conventional alpha-turn coil are connected to each other via a feed through part extending in the inner peripheries of the spiral parts.

Therefore, if the spiral parts are arranged in the same plane, the feed through part should be arranged from an upper wall or a lower wall of the spiral part to the outer periphery. Accordingly, the thickness of the alpha-turn coil becomes the feed through thickness thicker.

Therefore, when using the alpha-turn coil described in the Patent Document 1 as a position detecting sensor, the alpha-turn coil the feed through thickness thicker is inserted into a magnetic gap of a magnetic circuit. Therefore, the magnetic gap of the magnetic circuit is increased, and magnetic efficiency is reduced, so that a sensitivity of the position detecting sensor is reduced.

Further, according to the conventional alpha-turn coil described in Patent Document 1, when the spiral parts are arranged in the same plane, the feed through part is extended from the upper wall or the lower wall of the inner periphery to the outer periphery. Therefore, a lot of labor hours are needed for arranging the lead wires. Therefore, workability of arranging the lead wires is reduced, and a large receiving space is needed. Therefore, a device using the alpha-turn coil becomes large-sized.

Further, according to the conventional alpha-turn coil described in Patent Document 1, when connecting the spiral parts, because the spiral parts are overlapped with each other, a large receiving space is needed. Therefore, a device using the alpha-turn coil becomes large-sized.

Further, according to the conventional alpha-turn coil described in Patent Document 1, because the coil is made of conductive foil, when the coil is produced or when the coil is attached to electric or electronic parts, by applying an outer force such as pulling force or compressing force, the alpha-turn coil is deformed. Therefore, a direction of high frequency current passing through the coil is confused, or an eddy current generated around the alpha-turn coil is largely deformed. Therefore, performance of the alpha-turn coil is reduced.

Accordingly, an object of the present invention is to provide an alpha-turn coil which allows a narrow magnetic gap when the alpha-turn coil is used in a position detecting sensor or the like, and allows the position detecting sensor or the like to increase magnetic efficiency and sensitivity, and which is solid and hardly deformed with respect to outer pulling force or outer compressing force when the alpha-turn coil is produced, or after the alpha-turn coil is attached to electric parts or electronic parts, and which prevent a direction of electric current from being confused, generates little noise to improve reliability of a product using the alpha-turn coil, and of which lead wire part is effectively produced to drastically reduce wiring man-hours. Further, production efficiency of the alpha-turn coil is high, and a receiving space for the alpha-turn coil is reduced. A device using the alpha-turn coil can be small-sized. Further, the alpha-turn coil can be mass-produced, and a production cost and an assembling cost of the alpha-turn coil are reduced.

### SUMMARY OF THE INVENTION

In order to attain the object, according to the present invention, there is provided an alpha-turn coil including:

a plurality of coil main bodies made by winding a wire rod having a desired diameter; and

lead wire having a start part and a stop part formed integrally with outer peripheries of the coil main bodies, and connecting the coil main bodies to each other,

wherein the stop part of the lead wire of a forward coil main body is extended to the start part of the lead wire of a backward coil main body, and the lead wire is extended to compose the coil main body.

Preferably, the coil main body and the lead wire are made of an insulated wire rod having a desired diameter, and the start part and the stop part of the lead wire are integrally formed at the outer periphery of the coil main body.

Preferably, the coil main body is composed of a desired number of layers overlapped with each other, said layer is made by winding the wire rod.

Preferably, the coil main body is made by winding the wire rod in a desired number of windings.

Preferably, the coil main bodies are made by winding the wire rod in respective desired numbers of windings.

Preferably, the coil main body is made by winding the wire rod having 0.05 to 0.10 mm diameter in several to several thousand turns from an inner periphery to an outer periphery of the alpha-turn coil.

Preferably, the coil main body is formed in a donut shape, an oval shape, a sector shape, or a rectangular shape having a hollow center by winding the wire rod.

Preferably, a section of the wire rod has any one of circular, oval, square, round-cornered rectangular or rectangular shape.

These and other objects, features, and advantages of the present invention will become more apparent upon reading of the following detailed description along with the accompanied drawings.

### BRIEF DESCRIPTION OF THE DRAWINGS

FIG. 1 is a plan view showing a first embodiment of an alpha-turn coil according to the present invention;

FIG. 2 is an enlarged plan view showing a part of the alpha-turn coil;

FIG. 3 is an enlarged perspective view showing a second embodiment of the alpha-turn coil according to the present invention; and

FIG. 4 is a plan view showing a third embodiment of the alpha-turn coil according to the present invention.

### DETAILED DESCRIPTION OF THE PREFERRED EMBODIMENTS

Hereafter, an embodiment of an alpha-turn coil according to the present invention will be explained with reference to figures.

### First Embodiment

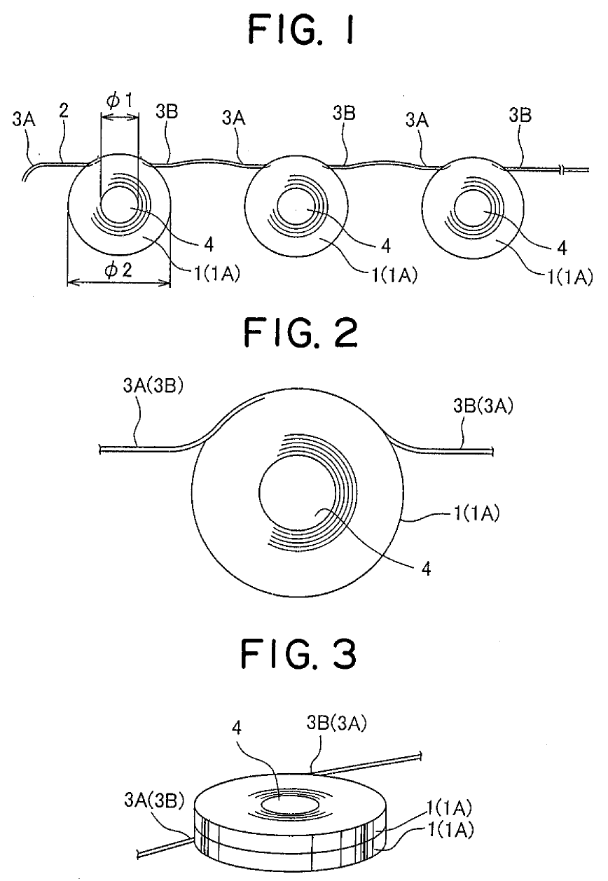

FIG. 1 is a plan view showing a first embodiment of the alpha-turn coil according to the present invention. FIG. 2 is an enlarged view showing a part of the alpha-turn coil.

The first embodiment of the alpha-turn coil includes: a plurality of coil main bodies 1 made by winding a wire rod 2 having a desired diameter; and lead wire 3A, 3B having a start part and a stop part formed integrally with outer peripheries of the coil main bodies 1, and connecting the coil main bodies 1 to each other. The stop part of the lead wire 3B of a forward coil main body 1 is extended to the start part of the lead wire 3A of a backward coil main body 1, and the lead wire is extended to compose the coil main body 1.

The coil main body 1 is made by winding the wire rod 2 having 0.05 to 0.10 mm diameter in several to several thousand turns from an inner periphery to an outer periphery of the alpha-turn coil. The start part 3A and the stop part 3B of the lead wire are integrally formed at the outer periphery of the coil main body 1.

According to the first embodiment as shown in FIG. 1, the coil main body 1 is formed in a flat spiral 1A of which inner periphery φ1 is about 5 to 10 mm, and outer periphery φ2 is about 10 to 20 mm having a hollow 4 in the center thereof. Further, the coil main bodies 1 are wound in the same plane via the lead wires 3A, 3B. Further, according to the first embodiment, the coil main body 1 is wound in desired turns, about 20 to 200 turns from the inner periphery to the outer periphery. However, these sizes of the inner periphery φ1, outer periphery φ2 of the coil main body 1 are only examples, and the present invention is not limited to these.

Further, an outer shape of the coil main body 1 is not limited to circle, and may be oval, sector, or rectangular. For example, when inserting an iron core or a yoke into the hollow 4, the inner shape of the coil main body 1, namely, the shape of the hollow 4 is selected from among the circle, oval, sector, and rectangular corresponding to the shape and size of the iron core or the yoke.

Further, a shape of a cross-section of the wire rod 2 is selected from among circle, oval, square, round-cornered rectangular and rectangular. This wire rod 2 is made of such as copper, aluminum, or an alloy of these having good conductivity. A surface of the wire rod 2 is insulated with such as synthetic resin or rubber.

According to the first embodiment as described above, because the start part and the stop part of the lead wire are integrally formed at the outer periphery of the coil main body 1, and the stop part of the lead wire of the forward coil main body 1 is extended to the start part of the lead wire of the backward coil main body 1, the alpha-turn coil composed of a plurality of coil main bodies 1 is effectively produced.

Conventionally, the spiral part is separated from the lead wire, and attached to the lead wire by soldering or adhering. According to the first embodiment of the present invention, because the lead wire is integrally formed with the spiral part (coil main body 1), and the stop part of the lead wire of the forward coil main body 1 is extended to the start part of the lead wire of the backward coil main body 1, further, the wire rod 2 is insulated, electrical insulating properties of the alpha-turn coil is increased, current loss of the alpha-turn coil is reduced, a flow direction of the high frequency current is not confused, and a noise generated owing to the deformation of the eddy current is reduced. Thus, the alpha-turn coil having high performance, high stability and high reliability is attained.

Further, because the lead wires 3A, 3B are arranged at the outer periphery of the coil main body 1, a connecting direction to the terminal is not restricted, and a connecting work is easily and surely done.

Further, according to the first embodiment of the present invention as described above, because the lead wire is integrally formed with the coil main body 1 at the outer periphery thereof, and the stop part of the lead wire of the forward coil main body 1 is extended to the start part of the lead wire of the backward coil main body 1 using the insulated wire rod 2, man-hour for wiring is drastically reduced, and productivity is increased, and the alpha-turn coil is adapted to mass-production. Thus, the alpha-turn coil composed of the coil main bodies 1 can be produced at low cost.

Further, because the stop part 3B of the lead wire of the forward coil main body 1 is extended to the start part 3A of the lead wire of the backward coil main body 1, and the coil main bodies 1 are connected to each other via the lead wires, and further, the lead wires 3A, 3B are integrally formed at the outer periphery of the coil main body 1, even when a diameter of the wire rod 2 is small such as 0.05 to 0.10 mm, the wire rod 2 is prevented from being deformed or broken at the production or the assembling of the alpha-turn coil. Thus, a structure of the alpha-turn coil is solid, and a yield of the alpha-turn coil is increased.

Further, according to the alpha-turn coil of the first embodiment, because the coil main body is made of the wire rod 2 of which diameter is 0.05 to 0.10 mm, and wound in 20 to 200 turns from the inner periphery to the outer periphery, space occupancy of the coil main body 1 is increased, and high frequency current flows properly and effectively via the coil main body due to the skin effect.

Thus, the start part 3A and the stop part 3B of the lead wires are integrally formed at the outer periphery of the spiral part 1A. Therefore, when using the alpha-turn coil of the first embodiment of the present invention in a magnetic sensor such as a position detecting sensor, or an angle detecting sensor, a magnetic gap of a magnetic circuit is drastically reduced. Therefore, magnetic efficiency is increased.

### Second Embodiment

FIG. 3 shows a second embodiment of the alpha-turn coil according to the present invention. According to the second embodiment, a desired number of the coil main bodies 1 are overlapped with each other. In FIG. 3, two coil main bodies 1 are overlapped with each other.

According to the third embodiment, a plurality of coil main bodies 1 are overlapped with each other, and a pair of start and stop parts 3A, 3B of the lead wires are formed at the outer periphery of the coil main bodies 1. Therefore, productivity of the alpha-turn coil is increased. Further, wiring workability is increased. Further, the magnetic gap of the magnetic circuit is reduced and the magnetic efficiency is increased.

Further, in the alpha-turn coil of the second embodiment, a foil is not used as the conventional alpha-turn coil. Therefore, when the alpha-turn coil is produced, or attached to electric parts or electronic parts, the alpha-turn coil is prevented from being deformed under the pulling force or the compressing force.

### Third Embodiment

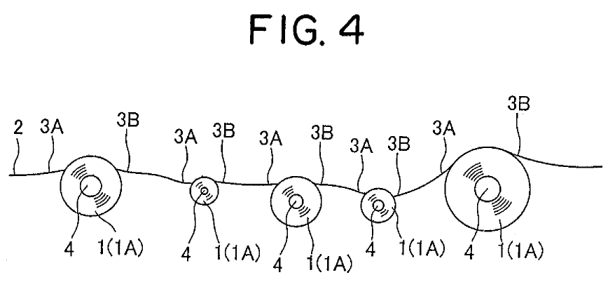

FIG. 4 shows a third embodiment of the alpha-turn coil according to the present invention. According to the third embodiment, the coil main bodies are wound in desired turns respectively. Therefore, inductance is controlled per each coil main body. Thus, the magnetic characteristic is increased. Flexibility of productions is increased.

As described the above, the alpha-turn coil is used in the magnetic sensor such as the position detecting sensor or the angle detecting sensor. Moreover, the alpha-turn coil is used in a linear coil, a choke coil, a battery, a transformer, a voice coil, or the like.

Although the present invention has been fully described by way of example with reference to the accompanying drawings, it is to be understood that various changes and modifications will be apparent to those skilled in the art. Therefore, unless otherwise such changes and modifications depart from the scope of the present invention hereinafter defined, they should be construed as being included therein.

What is claimed is:

1. An alpha-turn coil comprising:
a plurality of coil main bodies made by winding a wire rod having a desired diameter; and
lead wire having a start part and a stop part formed integrally with outer peripheries of the coil main bodies, and connecting the coil main bodies to each other,
wherein the stop part of the lead wire of a forward coil main body is extended to the start part of the lead wire of a backward coil main body, and the lead wire is extended to compose the coil main body.

2. The alpha-turn coil as claimed in claim 1,
wherein the coil main body and the lead wire are made of an insulated wire rod having a desired diameter, and
wherein the start part and the stop part of the lead wire are integrally formed at the outer periphery of the coil main body.

3. The alpha-turn coil as claimed in claim 1,
wherein the coil main body is composed of a desired number of layers overlapped with each other, said layer is made by winding the wire rod.

4. The alpha-turn coil as claimed in claim 1,.
wherein the coil main body is made by winding the wire rod in a desired number of windings.

5. The alpha-turn coil as claimed in claim 1,
wherein the coil main bodies are made by winding the wire rod in respective desired numbers of windings.

6. The alpha-turn coil as claimed in claim 1,
wherein the coil main body is made by winding the wire rod having 0.05 to 0.10 mm diameter in several to several thousand turns from an inner periphery to an outer periphery of the alpha-turn coil.

7. The alpha-turn coil as claimed in claim 1,
wherein the coil main body is formed in a donut shape, an oval shape, a sector shape, or a rectangular shape having a hollow center by winding the wire rod.

8. The alpha-turn coil as claimed in claim 1,
wherein a section of the wire rod has any one of circular, oval, square, round-cornered rectangular or rectangular shape.
